(19) United States
(12) Patent Application Publication
(10) Pub. No.: US 2020/0040184 A1
(43) Pub. Date: Feb. 6, 2020

(54) SELF-HEALING POLYMER COMPOSITION AND ASSOCIATED USES

(71) Applicant: Ezat EL-SAID, Orlando, FL (US)

(72) Inventor: Ezat EL-SAID, Orlando, FL (US)

(21) Appl. No.: 16/052,699

(22) Filed: Aug. 2, 2018

(51) Int. Cl. C08L 83/04; C08K 5/07; C08K 3/08; C08K 7/02; C08K 3/04

(52) U.S. Cl. CPC C08L 83/04; C08K 5/07; C08L 2312/00; C08K 7/02; C08K 3/041; C08K 3/08

(57) ABSTRACT

A self-healing polymer composition includes a polymer backbone having at least one amine terminated end group. The polymer backbone is selected from the group consisting of a polymerized siloxane and an aliphatic polyether and preferably polydimethylsiloxane. A cross-linker is selected from the group consisting of a 1,3,5-triarylbenzene, a triaryl-amine and 2,4,6-trichloro-1,3,5-benzenetricarbaldehyde, and preferably is 1,3,5-tris-(4-formylphenyl) benzene.

### FIELD OF THE INVENTION

The present invention relates to the field of self-healing materials and more particularly, this invention relates to the field of reversible, intrinsic self-healing polymer compositions.

### BACKGROUND OF THE INVENTION

Self-healing materials have the built-in ability to repair damage to themselves when they are damaged without the need for detection or repair by manual intervention of any kind. Many self-healing materials are polymers or elastomers and may be activated in response to an external stimulus such as light, temperature change, or other stimulus to initiate the healing process. At a molecular level, traditional polymers will cleave their sigma bonds when yielding to mechanical stresses via homolytic or heterolytic bond cleavage. Diels-Alder-based polymers cleave via a reversal of the cycloaddition reaction that forms the initial linkage.

There are typically two major types of self-healing polymers that can be selected depending on end uses and other requirements, i.e., intrinsic and extrinsic. The intrinsic polymer-based systems may inherently restore their integrity and may be reversible. Extrinsic polymers, on the other hand, are usually autonomous and extrinsic systems may require an external trigger for the healing to take place such as a thermal-mechanical, electrical or photo-stimulus. The extrinsic polymers may have a healing agent pre-embedded into them. Examples include vascular and capsule-based self-healing polymers.

In the intrinsic or reversible self-healing polymers, the polymer is inherently able to restore its integrity and can revert to an initial polymerized state whether the damaged state is monomeric, oligomeric, or non-cross-linked polymers. Some of these polymers use imine (Schiff based) chemistry where an amine nitrogen acts as a nucleophile attacking a carbonyl carbon. Several known examples use 1,3,5-triformylbenzene (TFB) as a cross-linker. An example self-healing composition using this cross-linker is described by Chao et al. in the article entitled, “Dynamic Covalent Polymer Networks Based on Degenerative Imine Bond Exchange: Tuning the Malleability and Self-Healing Properties by Solvent,” PUBS.ACS.ORG\macromolecules, 2016, 49, 6277-6284, the disclosure which is hereby incorporated by reference in its entirety.

Chao et al. describes covalent polymeric networks composed of imine cross-linkages that have been prepared by condensation polymerization of poly (ethylene glycol) bis(3-aminopropyl) with 1,3,5-triformylbenzene using an equimolar ratio of imine and aldehyde functionalities in organic solvents with varying polarity.

Another example is described in the article by Zhang et al. entitled, “A Transparent, Highly Stretchable, Autonomous Self-Healing Poly(dimethyl siloxane) Elastomer,” Macrmol. Rapid Comm., 2017, the disclosure which is hereby incorporated by reference in its entirety. Zhang et al. describes a self-healing poly(dimethyl siloxane) (PDMS) elastomer that joins with TFB and uses the reversibly dynamic imine bond as the self-healing points into the poly(dimethyl siloxane) (PDMS) networks. This self-healing polymer has relatively good optical transmittance and is highly elastic. Improvements of these and similar types of self-healing compositions, however, are desirable since self-healing polymer compositions are becoming increasingly more important in research and different uses in industry.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

A self-healing polymer composition comprises in an example a polymer backbone having at least one amine terminated end group. The polymer backbone is selected from the group consisting of a polymerized siloxane and an aliphatic polyether. A cross-linker is selected from the group consisting of a 1,3,5-triarylbenzene, a triaryl-amine and 2,4,6-trichloro-1,3,5-benzenetricarbaldehyde or other 1,3,5-benzenecarbaldehydes having other electrophilic groups in place of carbon.

In an example, the polymerized siloxane may have the structure,

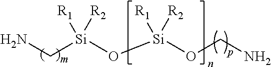

wherein R₁ and R₂ are independently selected from the group consisting of H and C₁-C₆ alkyl, wherein n is 1-100, and wherein m and p are from 1-6. The polymerized siloxane may have a molecular weight of 290 to 16,000 g mol⁻¹. The polymerized siloxane may comprise polydimethylsiloxane (PDMS).

In yet another example, the aliphatic polyether may have the structure,

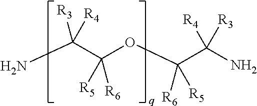

wherein R₃, R₄, R₅, and R₆ are independently selected from the group consisting of H and C₁-C₆ alkyl, and wherein q is 1-120. The aliphatic polyether may comprise polyethylene glycol or propylene glycol.

In still another example, the 1,3,5-triarylbenzene cross-linker and the triaryl-amine cross-linker both may have the structure,

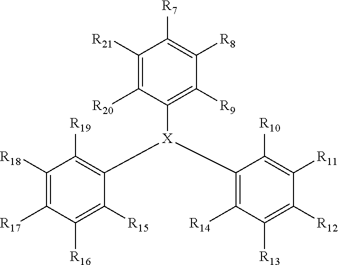

wherein R₇, R₈, R₉, R₁₀, R₁₁, R₁₂, R₁₃, R₁₄, R₁₅, R₁₆, R₁₇, R₁₈, R₁₉, R₂₀ and R₂₁ are each independently selected from the group consisting of a halogen (Br, Cl, F or I), OR²², NR²³R²⁴, NHOH, NO₂, CN, CF₃, C₁-C₆ alkyl, C₂-C₆ alkenyl, C₂-C₆ alkynyl, C₆-C₁₀ aryl, C(═O)R²², C(═O)H, CO₂R²², OC(═O)R²², C(═O)NR²³R²⁴, OC(═O)NR²³R²⁴, NR²³C(═S)R²² or S(O)_{y}R²², and wherein at least one substituent must be C(═O)H, and wherein R²² is, at each occurrence, independently selected from the group consisting of H and C₁-C₆ alkyl; and wherein R²³ and R²⁴ are, at each occurrence, independently selected from the group consisting of H and C₁-C₆ alkyl, and wherein R²³ and R²⁴ form together a heterocyclic group having from 3 to 7 atoms, and wherein X for the 1,3,5-triarylbenzene cross-linker is a 1,3,5 substituted benzene group and X for the triaryl-amine cross-linker is N.

The 1,3,5-triarylbenzene cross-linker may comprise 1,3,5-tris-(4-formylphenyl) benzene (TFPB). The triaryl-amine cross-linker may comprise tris(4-formylphenyl)amine (TFA). The polymer backbone may have a molecular weight in the range of 200 to about 16,000 g mol⁻¹. A carbon nanoadditive may be included or a metallic nanostructures, and the self-healing polymer composition may coat the carbon nanoadditive or a metallic nanostructure. The nanoadditive may comprise carbon or metallic nanowires, nanotubes, or other nanostructures.

In another example, the self-healing polymer composition may comprise a polymer backbone comprising bis(amine)-terminated poly(dimethylsiloxane) and a cross-linker comprising 1,3,5-tris-(4-formylphenyl) benzene (TFPB). The polymer backbone may have the molecular weight of 290 to 16,000, and the self-healing polymer composition may coat a nanoadditive, which may comprise carbon or metallic nanowires, nanotubes, or other nanostructures.

A self-healing polymer composition may comprise a polymer backbone having a structure selected from the group of:

### I)

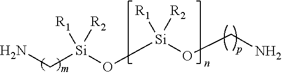

wherein R₁ and R₂ are independently selected from the group consisting of H and C₁-C₆ alkyl, wherein n is 1-100, and wherein m and p are from 1-6, and

### II)

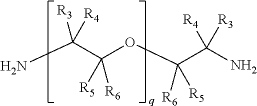

wherein R₃, R₄, R₅, and R₆ are independently selected from the group consisting of H and C₁-C₆ alkyl, and wherein q is 1-120. The cross-linker has the structure:

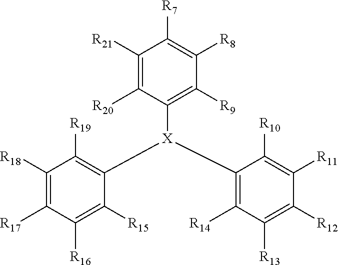

wherein R₇, R₈, R₉, R₁₀, R₁₁, R₁₂, R₁₃, R₁₄, R₁₅, R₁₆, R₁₇, R₁₈, R₁₉, R₂₀ and R₂₁ are each independently selected from the group consisting of a halogen (Br, Cl, F or I), OR²², NR²³R²⁴, NHOH, NO₂, CN, CF₃, C₁-C₆alkyl, C₂-C₆ alkenyl, C₂-C₆ alkynyl, C₆-C₁₀ aryl, C(═O)R²², C(═O)H, CO₂R²², OC(═O)R²², C(═O)NR²³R²⁴, OC(═O)NR²³R²⁴, NR²³C(═S)R²² or S(O)_{y}R²², and wherein at least one substituent must be C(═O)H, and wherein R²² is, at each occurrence, independently selected from the group consisting of H and C₁-C₆ alkyl; and wherein R²³ and R²⁴ are, at each occurrence, independently selected from the group consisting of H and C₁-C₆ alkyl, and wherein R²³ and R²⁴ form together a heterocyclic group having from 3 to 7 atoms, and wherein X is selected from the group consisting of N, P, and a 1,3,5 substituted benzene group.

The polymer backbone structures I and II may have a molecular weight between 290 and 16,000 and may include a nanoadditive or other nanostructures, said composition coating the nanoadditive or other nanostructures. The nanoadditive may comprise carbon or metallic nanowires, nanotubes, or other nanostructures.

### DESCRIPTION OF THE DRAWINGS

Other objects, features and advantages of the present invention will become apparent from the Detailed Description of the invention which follows, when considered in light of the accompanying drawings in which:

FIG. 1A shows a stainless steel member immersed into a NaCl aqueous solution and partially coated with the self-healing polymer composition as a transparent PDMS polymer cross-linked with the TFPB (PDMS-TFPB).

FIG. 1B shows the partially coated stainless steel member immersed in the NaCl solution for 15 days and showing the coating removed after the test was completed.

FIG. 2A shows an example self-healing transparent PDMS polymer composition that is cross-linked with TFPB and showing a fully cured self-healing polymer composition.

FIG. 2B shows the self-healing polymer composition of FIG. 2A cut into two pieces.

FIG. 2C shows the two pieces of FIG. 2B brought in full contact with each other.

FIG. 2D shows the self-healing polymer composition almost healed after 20 minutes of compression.

FIG. 2E shows the partially healed polymer composition stretched initially.

FIG. 2F shows the partially healed polymer composition stretched slowly to demonstrate the recovery of its mechanical properties.

FIG. 3A is a graph showing the load versus crosshead extension for Sample A as the PDMS-TFPB self-healing polymer composition in accordance with a non-limiting example.

FIG. 3B is a graph showing the load versus crosshead extension for Sample Z as the known PDMS polymer cross-linked with TFB as a PDMS-TFB composition.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

The self-healing polymer composition may be used for many different applications including a coating for metals and similar materials. The basic chemical parameters of the self-healing polymer composition of the current invention include in various examples an Imine Schiff Base reaction and components reacting with an aldehyde group. As noted before, it was known to use a single, basic benzene ring component as 1,3,5-triformylbenzene (TFB) that is combined with poly(ethylene glycol) bis (3-aminopropyl) or with poly dimethyl siloxane (PDMS) elastomer to form a self-healing polymer. The chemical formula for TFB is shown below, together with the poly(ethylene glycol) bis (3-aminopropyl) and PDMS, which have been synthesized with the TFB to form self-healing polymers as described in Chao et al. and Zhang et al.

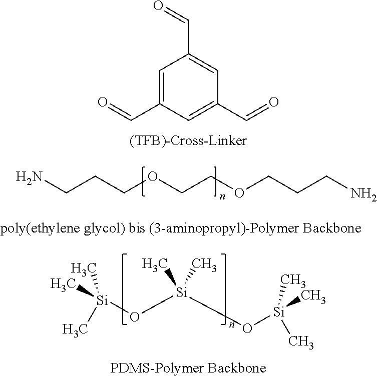

As illustrated, with the TFB cross-linker, the benzene ring includes formyl groups attached to it. The inventor has surprisingly discovered that the addition of benzene rings on the basic cross-linker contributes to pi-stacking interactions between adjacent aromatic rings, which contributes to a higher tensile strength. This allows thinner coatings to be applied with the same strength, and overall a stronger self-healing polymer. The inventor had discovered that the additional benzene rings in 1,3,5-tris-(4-formylphenyl) benzene (TFPB) or tris-(4-formylphenyl) amine (TFA) and joined with the cross-linker TFPB enhances the properties of the self-healing polymer composition as compared to using TFB as a cross-linker, and making the resulting composition stronger and operate as a better coating and having other superior properties. The self-healing polymer composition found to be advantageous is PDMS having a molecular weight of about 5,000 g mol⁻¹ as a non-limiting example combined with the TFPB having the additional benzene rings, and molecular weight throughout is grams per mole.

It was also found advantageous to use a polymer backbone as poly(propylene glycol) bis (2-amino-propyl ether) having molecular weights of about 2,000 and 4,000 g mol⁻¹ as a non-limiting example combined with the TFPB. The self-healing polymer includes a polymer backbone with the amine terminated end groups and cross-linker with preferably at least one benzene group and aldehyde group dissolved in a polar solvent to form the polymer in an example. The polymer backbone can vary greatly in molecular weight and number of monomer units as long as it contains amine terminated end groups, and in an example could be polyalkylene ethers and PDMS. Other potential polymer backbones include silicon-based organic polymers that have the amine terminated end groups.

The self-healing polymer compositions could be used for artificial muscles or a dielectric, for example, a capacitor or other device as having a conducting layer and insulating layer. Applying a voltage could compress the polymer due to conductive layers being attracted to each other. The self-healing polymer could be used as a screen for two conducting layers that could simulate compression of artificial muscles. Proof-of-concept sensors have been demonstrated such as gas sensors. During production, it would be possible to dissolve a cross-linker such as the PDMS as described above into a solvent and mix it with the polymer backbone under different solvent, temperature, pressure and other conditions, while applying a vacuum to evaporate the solvent. This may not include imines. Different solvents may be chosen to impart different adhesive properties.

One beneficial aspect of using PDMS as a polymer backbone is it is hydrophobic and aids in anti-corrosion and the inventor has found a preferred self-healing polymer composition is the TFPB/PDMS. In that self-healing composition, PDMS is inert, non-toxic (biocompatible), and a non-flammable polymer. These properties allow for a range of applications from coatings to flexible electronics as described briefly above and in further detail below. The inventor has also found polypropylene glycol as a polymer backbone with TFPB useful because that self-healing composition has been found acceptable for adhesives and coatings with surprisingly beneficial results

Since PDMS is hydrophobic, the PDMS combination with TFPB and similar self-healing compositions as described is advantageous as an anti-corrosion coating for metals such as stainless steel. Not only can the self-healing polymer be applied as a coating for anti-corrosion, but it can also be used for various applications, such as paint coatings due to its transparency. Unlike many current self-healing polymers on the market, this self-healing polymer composition coating does not require an external stimulus and can heal autonomously at ambient conditions (room temperature). Some of the different examples take more time than others for self-healing, but can clearly be sped up by an external stimulus such as heat.

The PDMS self-healing polymer has adhesive properties and a preferred TFPB/PDMS has been found to be an advantageous adhesive used in flexible electronics. For example, this and other self-healing polymer compositions as described can be used as substrates for solar models. Due to its dielectric properties, it can function as an insulator for a conducting circuit and can be used to make a dielectric actuator. This can be very useful in the construction of an artificial muscle. Also, its adhesive properties are advantageous because the polymer can be peeled off and reused again.

PDMS is commonly used in medicine and cosmetics and giving it a self-healing ability proves useful. Currently, PDMS is commonly used for skin, hair, and food applications. Applications in the medical field can be incorporated with electronics. The self-healing polymer can potentially be used for contact lenses that may house electronic components. The self-healing polymers can also be applied to eyewear, and not only contacts. The self-healing polymer can also be used as an artificial skin and formulated as a sensor for touch perception for burn patients and robotics.

These self-healing polymers can be modified for embedding various components and can be self-cleaning, antifouling, water repellent, and used for oil-water separation. These self-healing polymers as described can also be applied to clothing (fabrics), metal, glass, and plastics. Since many of these self-healing polymers such as the preferred PDMS-TFPB can heal in aqueous solution, they can be used for marine applications. In yet another example, the Tris(4-formylphenyl)amine cross-linker when combined with PDMS can change color such as when acetone is added to it and can change from yellow to bright red. Furthermore, the self-healing polymers of the current invention can potentially be used as a “smart window” coating, e.g., as an electrochromic display. Therefore, the polymers can be used in mechanical, optical, acoustic, and electronic devices. It is possible to use the self-healing polymer composition of the current invention with different sensors and use it with nanowires such as for a coating, and place it on indium and oxide substrates. This is an example of a “smart window” and with an applied voltage, it can potentially work.

It is possible to add silicon nanoparticles and carbon nanoadditives and other metallic nanostructures. The self-healing polymer composition in accordance with an example of the current invention may incorporate the carbon nanoadditive and could include carbon nanowires or nanotubes. Metallic nanorods can be embedded into the polymer or placed on top of the polymer, for example, the metallic nanorods can be layered on both sides of the polymer to form a capacitor. Potentially, nanoadditives can be used with the self-healing polymer so that an applied voltage could be used and change the color in certain examples and depending on voltage, and it could block infrared or visible light depending on its characteristics. Furthermore, adding silicon nanoparticles can potentially have an effect on its transmittance when the polymer is stretched. An example of such teaching is found in the article entitled, “A Robust Smart Window: Reversibly Switching from High Transparency to Angle-Independent Structural Color Display,” Ge et al., Advanced Materials, 2015, the disclosure which is hereby incorporated by reference in its entirety. The TFPB/PDMS is advantageous since it is more durable and functional. Although PDMS has been used with TFB, it has been found that the extra benzene rings with the aldehydes impart better functionality and adhesiveness and appear to make the structure highly flexible. Also, it is possible to use triaryl amine as described above.

As noted before, it is known to use PEG with TFB as described by Chao et al. above, but the inventor has surprisingly found that PPG when applied with TFB, for example, is water insoluble and has other advantageous properties different that the TFP-PEG. It can also be combined with TFPB, and thus, it is possible to make PPG-TFB, and PPG-TFPB, and being water insoluble, that composition helping as a coating for stainless steel and other materials. The inventor had determined that thinner self-healing polymer films could be applied when using PDMS-TFPB as compared to the known PDMS-TFB. It was also determined that during production of the self-healing polymer, the more polar solvents were better when producing the PDMS-TFPB, while polar solvents such as DMF, chloroform, and toluene could also be used. DCM and DMSO are possible solvents.

As noted before, there are a variety of ways to heal a polymer, such as using microencapsulation, fiber tubing, etc. and the current self-healing polymer compositions as described use reversible covalent chemistry. Because of the advantageous mechanical properties as discovered by the inventor, the self-healing polymer composition has relatively fast autonomous healing. Generally, when dealing with self-repairable polymers, it is desirable to achieve benefits in three properties as self-healing kinetics, optical properties, and mechanical properties. Most self-repairable polymers contain favorable characteristics, but are not favorable in all three aspects. The current self-healing polymer compositions are transparent, highly elastic and durable, and can heal quickly with no external stimulus such as a catalyst, heat, and UV light. The inventor has found especially beneficial the TFPB cross-linker and PDMS polymer backbone. As noted above, the chemistry of this composition is based on the Schiff base reaction, where an aldehyde or ketone can undergo nucleophilic attack by an amine, forming an imine bond, which acts as a cross-linker between other polymers.

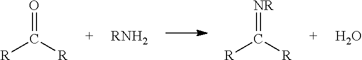

A primary amine is extended from the polymer backbone and can easily attack the cross-linker. Also, the preferred cross-linker as TFPB uses additional benzene rings which make the product formed more thermodynamically favorable. Furthermore, this polymer has unique mechanical properties due to the extra benzene rings. To create the polymer in one example, there is a polymer backbone with amine terminated end groups, and a cross-linker (with preferably at least one benzene group and aldehyde group) dissolved in a polar solvent. The polymer backbone may vary as long as it contains amine terminated end groups. For example, they can be Polyalkylene ethers, PDMS and possibly other potential silicon-based organic polymers that have amine terminated end groups. The cross-linker may be numerous compounds with at least one aldehyde group. However, in regard to the kinetics and self-healing ability, the aldehyde group(s) should be attached to at least one benzene group. It has also been found desirable that the cross-linker and polymer backbone be measured into a one to one mole ratio, but it is possible other mole ratios could be used during formation and change properties. The inventor carried out the experiments in a 1:1 ratio.

When performing the experiment to produce the various compositions, including the preferred PDMF-TFPB, the cross-linker was dissolved into a polar solvent, which was carried out with DMF. Further testing will occur with toluene and chloroform since these two solvents are more volatile and have lower boiling points, which makes it easier to remove the solvents after polymer synthesis is completed. It was found that the polymer containing the solvent has different physical properties than the polymer without the solvent. For all the cross-linkers experimented with, it was best to dissolve them in DMF, however, Tris(4-formylphenyl)amine (TFA) required a larger volume of solvent because it displayed a lower solubility. Also, some heat was applied with TFPB to help dissolve the cross-linker into DMF, because it was less soluble than other compounds such as TFB. This also shows that the TFPB has the different characteristics than the TFB when combined with PDMS, the resulting PDMS-TFPB has markedly different properties than the PDMS-TFB.

After making the cross-linker solution and measuring out the polymer backbone in two separate vials, the solutions were mixed together into one single vial. That mixture was placed into a vacuum for about an hour and a half. The vacuum was turned off and the contents left inside for 12 hours to complete synthesis. The vacuum would be turned on for another two hours to remove some of the polar solvent and after the polymer was removed from the vial. Normally, it requires more time to evaporate a solvent such as DMF, but in regard to practical results, only two hours were needed to differentiate a dry and solvent filled polymer. It was found that the differences between them were that the dry polymer was less elastic, more brittle, and had fewer adhesive properties. This procedure may differ based on the application desired of the polymer. This procedure was only used to create thin elastomer films for measuring.

The 1,3,5-triformylbenzene (TFB) component used previously by Zhang et al. and Chao et al. to produce their self-healing polymer compositions is shown below:

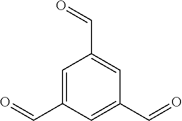 [SMILES: O=Cc1cc(C=O)cc(C=O)c1]

This cross-linker is often used in self-repairable, i.e., healing polymers. This cross-linker may be obtained from Sigma-Aldrich. The inventor has surprisingly found that 1,3,5-tris-(4-formylphenyl) benzene (TFPB) when combined with some polymer backbones such as PDMS has advantageous properties, function, and end use applications as compared to the typical TFB employed by Chao et al. and Zhang et al. The general chemical formula for TFPB is shown below:

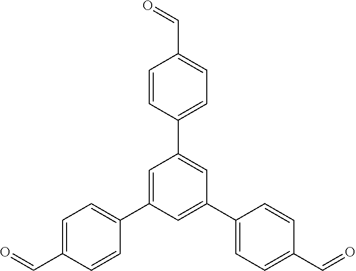 [SMILES: O=Cc1ccc(-c2cc(-c3ccc(C=O)cc3)cc(-c3ccc(C=O)cc3)c2)cc1]

Chemical vendors that sell this compound include AEchem Scientific Corporation, USA, Boerchem, LabNetwork, a WuXi AppTec Company, Yuhao Chemical, Alfa Chemistry, AKos Consulting & Solutions, ZINC, and 1717 CheMall Corporation. In the example described, the experiment as described was purchased as a compound from Alfa Chemistry.

The inventor has discovered that tris(4-formylphenyl)amine (TEA) may be used as a cross-linker with its more numerous benzene rings and with PDMS as noted above and shown below:

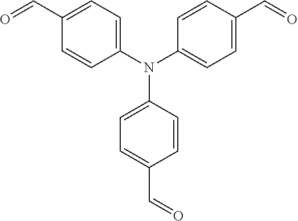 [SMILES: O=Cc1ccc(N(c2ccc(C=O)cc2)c2ccc(C=O)cc2)cc1]

This compound could potentially be used as an electrochromic film due to the triphenylamine. This compound may be obtained from Sigma-Aldrich. The inventor has also discovered that it is possible to use 2,4,6-trichloro-1,3,5-benzenetricarbaldehyde as an example as shown below:

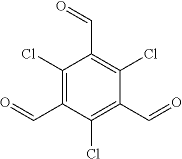 [SMILES: O=Cc1c(Cl)c(C=O)c(Cl)c(C=O)c1Cl]

Use of this compound results in a marked increase in the rate of polymer self-healing. It is believed this compound makes the polymer heal faster because of the electronegative chlorine atoms, which help make the carbon atoms on the aldehyde groups more electron withdrawing when undergoing a nucleophilic attack. This compound may be bought from Sigma-Aldrich. This effect will likely extend to similar compounds with electronegative substituents other than chlorine.

As noted before, different solvents such as DMF, Toluene, and Chloroform may be used to prepare the self-healing polymer, but other polar solvents are not excluded. These three listed solvents may be obtained from Sigma-Aldrich. Bis(amine)-terminated poly(dimethylsiloxane) (Product is DMS-A21) as a compound was obtained from Gelest. The polymer backbones of poly(propylene glycol) bis(2-amino-propyl ether) with molecular weights of 400, 2000, and 4000 g mol⁻¹ were obtained from Sigma-Aldrich and used in experiments as described below. A basic set-up for producing the self-healing polymer may include a flask vial and basic magnetic stir bar inside the flask vial, which was controlled by the magnetic stirrer with controlled laboratory conditions.

In an example, the PDMS polymer backbone was reacted with TFB with a basic set up such as described with the procedure of Zhang et al. The properties of this self-healing composition made the composition somewhat transparent, fairly elastic, strong, with some fast and autonomous healing, but having adhesive properties. It was anti-corrosive and it could heal in water.

In another experiment, PDMS polymer backbone was reacted with TFPB to form the self-repairable polymer composition of the current invention. This is a preferred composition in accordance with a non-limiting example, and the properties include a composition that was about the same transparency when heated as compared to the TFB/PDMS polymer. It appeared stronger and had fast and autonomous healing with stronger adhesive properties than the TFB/PDMS polymer. Its anti-corrosive was confirmed and it can heal in water. The difference in transparency previously described did not occur when the polymers were heated during synthesis.

In another experiment, PDMS polymer backbone was reacted with TFA to form a self-repairable polymer composition in accordance with a non-limiting example. The properties include a composition that is slightly opaque and has a yellow color. It is basically non-elastic and appears to be the strongest polymer from other compositions formed in the different experiments. It showed autonomous healing, but at a slow rate compared to the polymers produced with other cross-linkers. When heat was applied, it appeared to heal faster and could still heal without any stimulus to it. It had further electrochromic potential application and healed in water.

In an example, PDMS polymer backbone was reacted with 2,4,6-trichloro-1,3,5-benzenetricarbaldehyde to form another example of a self-repairable polymer composition in accordance with a non-limiting example. The properties included a composition that was opaque with an orange hue, highly elastic, but not as strong as the other listed cross-linkers, but close to them. The composition is tough and can take a large amount of strain before breaking. It had very fast and autonomous healing and healed in water. The rate of self-healing is a very important factor to consider when evaluating a polymer, and this increased rate is of significant importance when evaluating potential applications.

In yet another example experiment, PPG polymer (2000 g mol⁻¹) backbone was reacted with TFB to form a self-repairable polymer composition in accordance with a non-limiting example. Properties include a composition that is non-transparent and having solid to milky color and elastic, strong and durable and with slow and non-autonomous healing. This polymer required heat due to a higher glass transition temperature. Adhesive properties were found to be minimal.

PPG polymer (4000 g mol⁻¹) backbone was reacted with TFB to form another example of a self-repairable polymer composition in accordance with a non-limiting example. The properties include a composition as a non-standing free gel that can potentially be applied as a thin coat on solid surfaces that can heal scratches. Further testing is to be accomplished.

PPG polymer (400 g mol⁻¹) backbone was reacted with TFB in yet another example, but there was no successful reaction.

As will be explained in greater detail below, these self-repairable polymer compositions in accordance with these non-limiting examples as developed are useful because they can be applied as protective coatings to objects that undergo mechanical stress. For example, they can applied as coatings for paint that can repair scratches. This can be useful for multiple fields such as the automotive industry. Also, the polymer of greater interest based on the observable results, i.e., PDMS-TFPB, can also be used as an anti-corrosion covering. Corrosion is a large problem throughout the world, especially with climate change in various areas and costs annually $552 billion a year for the US to handle. A protective anti-corrosion coating that is elastic and can heal in ambient conditions, even in water is thus very valuable and desirable and the preferred PDMS-TFPB helps solve some of these longstanding needs, especially in specific applications.

As noted before, PDMS is non-toxic, inert, and non-flammable, making it useful in medicine, for example, when experimenting with artificial muscles. These self-healing polymers can be used as a flexible substrate for medical devices, for example, an insulin pump people wear on their arm and as a medical sensor.

As noted before, the self-healing polymer composition of the current invention can be used for flexible electronics and its use with flexible technology would eventually replace the current rigid technology. PDMS-TFPB and the similar self-healing polymers as produced possibly could be an excellent substrate to house circuit boards and electronic components and act as a sealant for flexible solar cells. Researchers at the NSTC are working on improving flexible solar cells and this self-healing polymer could be advantageous in these applications, and therefore, this self-healing polymer can be used in mechanical, optical, acoustic, and electronic devices.

As noted above, the self-healing polymer composition of the current invention and in accordance with a preferred example, includes a polymer backbone having at least one amine terminated end group. Although different polymer backbones may be used, two preferred polymer groupings are selected from the group consisting of a polymerized siloxane and an aliphatic polyether. One preferred polymerized siloxane is PDMS, while PPG is an example aliphatic polyether that may be used. Different cross-linkers may be used, but it has been found that a cross-linker selected from the group of a 1,3,5-triarylbenzene, a triaryl-amine and 2,4,6-trichloro-1,3,5-benzenetricarbaldehyde are advantageous.

In an example, the polymerized siloxane may have the general structural formula,

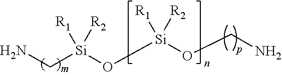

where R₁ and R₂ could be independently selected from the group of H and C₁-C₆ alkyl, where n is 1-100, and m and p are from 1-6. This polymerized siloxane structure may have a molecular weight between 290 to 16,000 g mol⁻¹. However, values can vary and molecular weights between 3,000 to 10,000 were found to be ideal, and with H₂N-PDMS-NH₂ molecular weights of 4,000 to 8,000 could be used, with experiments showing polymers in the range of 5,000 to 7,000 g mol⁻¹ to be ideal. The polymerized siloxane in a preferred example is formed as polydimethylsiloxane (PDMS) and includes the amine-terminated end groups.

In yet another example, when the aliphatic polyether is used, it may have the general structural formula,

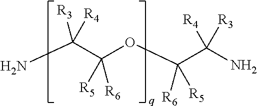

where R₃, R₄, R₅, and R₆ may be independently selected from the group of H and C₁-C₆ alkyl, and where q is 1-120. The aliphatic polyether may include polyethylene glycol or propylene glycol and derivatives thereof. In an embodiment, the molecular weight of the propylene glycol may be from about 230 to about 16,000 and the molecular weight of the polyethylene glycol may be about 200 to 16,000. Molecular weights can vary and could be about 1,000, 1,500, 2,000, 2,500, 3,000, and higher. The higher ranges could be more atypical for use.

The preferred cross-linkers have more than one benzene ring in its basic unit as noted above. For example, the 1,3,5-triarylbenzene cross-linker and the triaryl-amine cross-linker both may have the general structural formula,

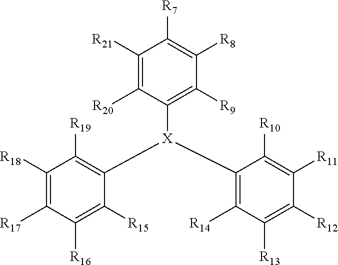

where R₇, R₈, R₉, R₁₀, R₁₁, R₁₂, R₁₃, R₁₄, R₁₅, R₁₆, R₁₇, R₁₈, R₁₉, R₂₀ and R₂₁ may each be independently selected from the group of a halogen (Br, Cl, F or I), OR²², NR²³R²⁴, NHOH, NO₂, CN, CF₃, C₁-C₆ alkyl, C₂-C₆ alkenyl, C₂-C₆ alkynyl, C₆-C₁₀ aryl, C(═O)R²², C(═O)H, CO₂R²², OC(═O)R²², C(═O)NR²³R²⁴, OC(═O)NR²³R²⁴, NR²³C(═S)R²² or S(O)_{y}R²², and where at least one substituent must be C(═O)H, and where R²² is, at each occurrence, independently selected from the group of H and C₁-C₆ alkyl. The R²³ and R²⁴ are, at each occurrence, independently selected from the group of H and C₁-C₆ alkyl, and where R²³ and R²⁴ form together a heterocyclic group having from 3 to 7 atoms. The X for the 1,3,5-triarylbenzene cross-linker may be a 1,3,5 substituted benzene group and X for the triaryl-amine cross-linker is nitrogen in a preferred example.

In an example, the 1,3,5-triarylbenzene cross-linker preferably is 1,3,5-tris-(4-formylphenyl) benzene (TFPB) and preferably combined with PDMS. In our example, the triaryl-amine cross-linker may be tris(4-formylphenyl)amine (TFA). The polymer backbone may have a molecular weight of about 200 to about 16,000, but can vary with about 1,000, 2,000, 3,000 or 4,000 molecular weight and ranges therebetween and variances. It should be understood that a carbon or metallic nanoadditive may be included and the composition may also coat a carbon or metallic nanoadditive, such as nanowires or nanotubes or metallic nanostructures.

A preferred example of the self-healing polymer composition includes a polymer backbone as bis(amine)-terminated poly(dimethylsiloxane) PDMS and its cross-linker as 1,3,5-tris-(4-formylphenyl) benzene (TFPB). This polymer backbone may have a molecular weight of 290 to 16,000, but can vary and can range from 1,000, to 4,000 or higher as noted, and the composition may coat a nanoadditive, which may comprise carbon or metallic nanowires or nanotubes and metallic nanostructures.

Other cross-linkers that may be used and include in an example the general structural formula,

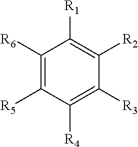

where R₁, R₂, R₃, R₄, R₅, and R₆ are each independently selected from the group of halogen (Br, Cl, F or I), OR²², NR²³R²⁴, NHOH, NO₂, CN, CF₃, C₁-C₆ alkyl, C₂-C₆ alcenyl, C₂-C₆ alcynyl, C₆-C₁₀ aryl, C(═O)R²², C(═O)H, CO₂R²², OC(═O)R²², C(═O)NR²³R²⁴, OC(═O)NR²³R²⁴, NR²¹C(═S)R²² or S(O)_{y}R²². In this example, at least one substituent must be C(═O)H. R²² is, at each occurrence, independently selected among H, C₁-C₆ alkyl and R²³ and R²⁴ are, at each occurrence, independently selected among H, C₁-C₆ alkyl, or R²³ and R²⁴ and form together a heterocyclic group having from 3 to 7 atoms. An experiment shows that selection of a chlorine atom as the substituent in 3 (three) alternating positions greatly increases the rate of self-healing, and this observation will probably extend to other electronegative/electron withdrawing substituents.

In yet another example, the cross-linker may have the general structural formula,

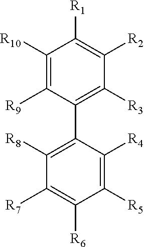

where R₁, R₂, R₃, R₄, R₅, R₆, R₇, R₈, R₉, and R₁₀ are each independently selected from the group of halogen (Br, Cl, F or I), OR²², NR²³R²⁴, NHOH, NO₂, CN, CF₃, C₁-C₆ alkyl, C₂-C₆ alcenyl, C₂-C₆ alcynyl, C₆-C₁₀ aryl, C(═O)R²², C(═O)H, CO₂R²², OC(═O)R²², C(═O)NR²³R²⁴, OC(═O)NR²³R²⁴, NR²¹C(═S)R²² or S(O)_{y}R²². At least one substituent must be C(═O)H. R²² is, at each occurrence, independently selected among H, C₁-C₆ alkyl; R²³ and R²⁴ are, at each occurrence, independently selected among H, C₁-C₆ alkyl, or R²³ and R²⁴ form together a heterocyclic group having from 3 to 7 atoms.

An example reaction between components such as a polymerized siloxane and a multiple benzene ring cross-linker such as a triaryl-amine or triaryl-benzene is shown below:

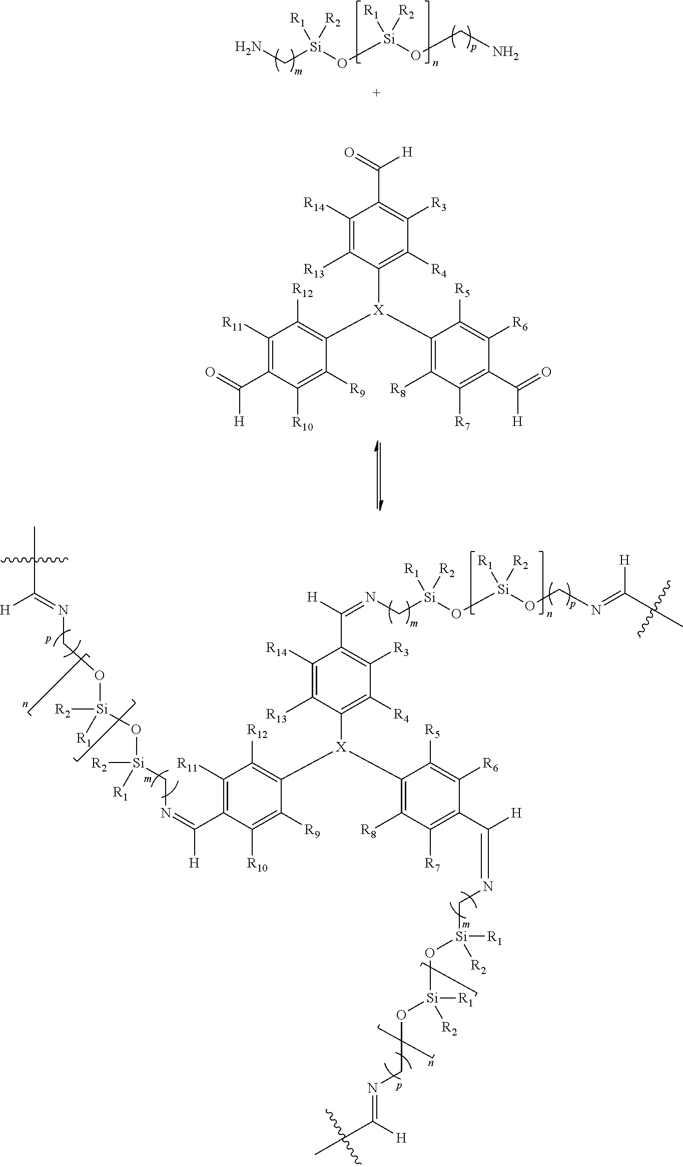

These polymers can be combined with other materials, from the macroscopic scale to the nanoscopic scale, to produce composites, as discussed previously with examples including dielectric actuators and sensors. These polymers can be combined with conducting polymers, such as poly(acetylene)s, poly(pyrrole)s, poly(indole)s, and poly(aniline)s to form capacitors. There are multiple types of metallic nanostructures and carbon nanostructures that can be embedded into the polymer. As mentioned previously, carbon nanotubes, such as SWNTs and MWNTs, can be embedded into the polymer. Other carbon nanostructures include but are not limited to fullerenes and graphene. Metallic nanostructures, such as silver nanowires, copper nanowires, and nanoparticles can be inserted into the self-healing polymer. Nanoparticles can be, but are not limited to, quantum dots, aluminum oxide, cellulose, ceramic, cobalt oxide, copper, gold, silver, iron, iron oxide, iron platinum, lipid, titanium dioxide.

It is possible to use the self-healing polymer composition with an added ionic conductor. It is also possible to use the self-healing polymer composition in wound healing and even high-performance electronic skin and self-healing super capacitors and self-healing heat sensors. It should be understood that natural animal muscle is a biomaterial and is a strong elastic material and self-healing. Thus, use of the self-healing polymer composition of the current invention in specific embodiments could provide simulated muscles. A good example is the use of the electrophilic functional groups, an example as 2,4,6-trichloro-1,3,5-benzenetricarbaldehyde. It is possible to include additives such as with the PDMS-TFPB self-healing polymer and other examples and change the strain fracture characteristics. The applications of the self-healing polymer composition with artificial muscles can be advantageous. The deformation in the polymer film or its stretching may have a low strain and small hysteresis, and thus, aid in use for artificial muscles, electronics, and other similar uses. For example, applications could include silicon nanoribbon electronics for skin prosthesis for artificial skin and prosthetics. It is possible to use the self-healing polymer compositions in mechanical and temperature sensor arrays such as stretchable humidity sensors and thermal actuators.

Many of the self-healing polymer compositions as described for the current invention are transparent or substantially transparent and it is possible to use polymer-metal hybrid transparent electrodes for flexible electronics and allow recovery of mechanical properties. Some devices break down due to mechanical damage caused by bending, accidental cutting, or scratching, and thus, the flexible transparent electronics using the self-healing polymer compositions can have high transmittance and robust flexibility.

It is also possible to apply these self-healing polymer compositions that are hydrophobic to fabrics, which is especially relevant in outdoor applications. This may aid not only in waterproofing, but help in small tears that self-repair. It also possible to apply the self-healing polymer compositions to various conductive carbon nanotube coatings such as for steel and help in self-cleaning surfaces. The carbon nanotubes could be a mesh structure. Different solvents can be used during the production to modulate imine bond exchange rates in some examples. These self-healing polymer compositions may also be advantageously used as adhesives to covalently bond to different surfaces bearing primary amine or aldehyde functional groups. Some may be resistant in water and others degraded in water to enhance environmental appeal.

It is possible to use a self-healing polymer coating such as a PDMS-TFPB coating to coat copper wire and develop flexible electronic components that can repair themselves to increase lifetime and reliability. Self-healing flexible circuits such as used with silver nanowire applications may be sensitive to specific chemicals on the elastomer. One advantage is the chemicals for preparing the self-healing polymers of the current invention such as the PDMS-TFPB elastomer are commercialized and readily synthesized and useful for anti-corrosion and antifouling in electronics, the marine environment, and human body. Sometimes the amine bond-containing polymer is sensitive to pH and the self-healing polymer composition can be remolded to different shapes by bearing the pH.

It is possible to embed hydrophobic silica nanoparticles with the self-healing polymers. These nanoparticles as additives may be non-polar and may increase diffusion path through the coating. Water may have no propensity to accumulate at the particle surface. The weight range could vary from between 1 and 30 or 40 weight percent, and in one concentration, about 15 and 25 weight percent. It is possible to include some hydrophobic silica particles of about 5 to 10 weight percent. It is possible to fill brittle-walled vessels with the self-healing polymer composition and use them with glass fiber layers. A possible example uses the triphenyl amine that is cross-linked with the PDMS as an electrochromic film. In this example, a reversible optical change in absorption and transmittance can be induced by external voltages and form electrochromic devices. It may repair cracks in various smart materials.

The PDMS polymer cross-linked with the TFPB (PDMS-TFPB) was tested by various methods and it was found that the inventive PDMS-TFPB was stronger and just as elastic as the known PDMS-TFB as explained in greater detail below.

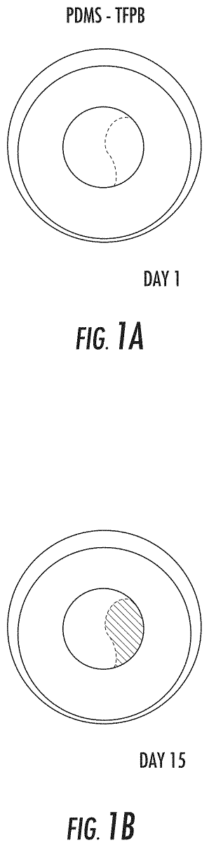

Referring now to FIGS. 1A and 1B, there is illustrated a stainless steel member immersed into a NaCl aqueous solution (4% wt. at 25° C.) for 15 days. It is partially coated with the self-healing polymer composition as a transparent PDMS-TFPB composition. The partially coated stainless steel sheet as immersed for one day is shown in FIG. 1. The dashed line indicates the dividing line where the PDMS-TFPB polymer was located. As shown in FIG. 1B, the partially coated stainless steel member had been immersed in the NaCl solution for 15 days and shows the coating removed after this test was completed.

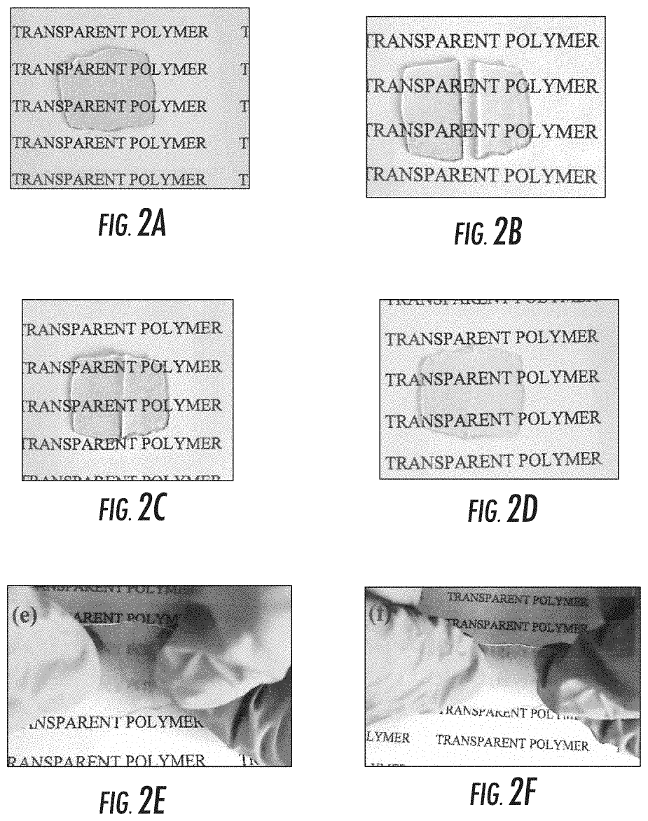

FIG. 2A illustrates an example of the transparent PDMS-TFPB and fully cured self-healing polymer composition formed as a thin film sample with an underlying sheet with the words “transparent polymer” printed thereon to show the transparent nature of the PDMS-TFPB self-healing polymer. It is then cut into two pieces (FIG. 2B) and then brought back into contact with each other (FIG. 2C) and a moderate amount of compression applied. The self-healing PDMS-TFPB polymer composition is almost healed after 20 minutes of compression (FIG. 2D). This partially healed PDMS-TFPB polymer composition shown in FIG. 2D is pulled (FIG. 2E) and stretched slowly to demonstrate the recovery of its mechanical properties (FIG. 2F).

Tensile testing of the PDMS-TFPB self-healing polymer composition of the current invention was accomplished and can be compared with mechanical testing of a known PDMS-TFB sample film. In the testing, Sample A corresponds to the PDMS polymer composition that is cross-linked with TFPB, i.e., PDMS-TFPB, and Sample Z corresponds to the known PDMS polymer composition that is cross-linked with TFB, i.e., PDMS-TFB. A sample of each in the form of thin films were originally provided and an additional portion of the second film as Sample Z (PDMS-TFB) was subsequently sent in order to yield sufficient material for the testing as indicated in the PSI identification for the PDMS-TFPB as the 21204-01 and the PDMS-TFB as the 21204-02 and 21204-03.

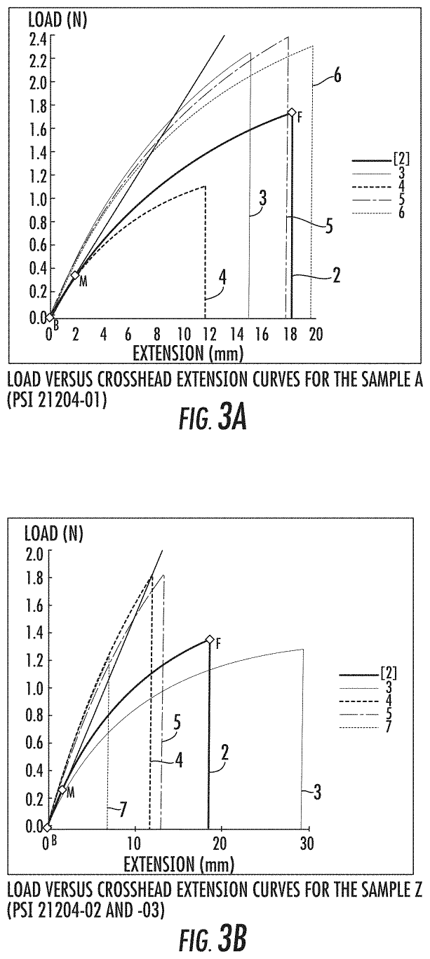

Tensile testing was performed in accordance with PSI Method ID 940 Revision 8. A MTS insight 30 load frame using a 100 N load cell was used for these measurements. Screw clamp grips were used with a gauge length of 22 millimeters, a preload force of 1 pound, and a test speed of 10 millimeters per minute. Due to the size of the films and their thickness variations, specimens were prepared using a microtensile ASTM D1708-13 “dog bone” die. Five replicates were tested for each sample and efforts were made to avoid any voids or other irregularities in the films as much as possible. FIGS. 3A and 3B show the load versus cross-head extension graphs for the respective testing of the PDMS-TFPB (FIG. 3A) and the known PDMS-TFB (FIG. 3B). The data are summarized in Table 1.

TABLE 1
SUMMARY OF TENSILE TESTING RESULTS

| | | | Peak | | Elongation |
|---|---|---|---|---|---|
| Client | PSI | | Load | Modulus | at Break |
| Identification | Identification | Replicate | (N) | (MPa) | (mm) |
| | | 2 | 1.76 | 0.77 | 18 |
| | | 3 | 2.27 | 0.72 | 15 |
| Clear Polymer | 21204-01 | 4 | 1.13 | 0.50 | 12 |
| PDMS-TFPB | | 5 | 2.40 | 0.77 | 18 |
| | | 6 | 2.33 | 0.68 | 20 |
| | | Average | 1.98 | 0.69 | 16 |
| | | St. Dev. | 0.54 | 0.11 | 3.2 |
| | | 2 | 1.36 | 0.53 | 18 |
| | | 3 | 1.30 | 0.48 | 29 |
| Clear Polymer | 21204-02 | 4 | 1.83 | 0.62 | 12 |
| PDMS-TFB | and | 5 | 1.83 | 0.62 | 13 |
| | 21204-03 | 7 | 1.23 | 0.58 | 6.9 |
| | | Average | 1.51 | 0.56 | 16 |
| | | St. Dev. | 0.30 | 0.06 | 8.4 |

Large standard deviations were obtained due to the variations in film thickness and some general irregularities that were present. The graphs and test results show that the inventive PDMS-TFPB self-healing polymer composition is stronger and just as elastic as the known PDMS-TFB composition.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A self-healing polymer composition, comprising:
a polymer backbone having at least one amine terminated end group, wherein the polymer backbone comprises a polymerized siloxane having a molecular weight of 290 to 16,000 gmol⁻¹ and comprises polydimethylsiloxane (PDMS) and having at least one amine terminated end group;
a cross-linker comprising 2,4,6-trichloro-1,3,5-benzenetricarbaldehyde; and
silicon nanoparticles embedded in the polydimethylsiloxane and cross-linker forming the composition that improves the hydrophobic properties of the composition.

2-20. (canceled)

21. A self-healing polymer composition, comprising:
a polymer backbone having at least one amine terminated end group, wherein the polymer backbone comprises polymerized siloxane having a molecular weight of 290 to 16,000 gmol⁻¹ and comprises polydimethysiloxane (PDMS); and
a cross-linker having the general structural formula, 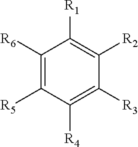
where R₁, R₃ and R₅ are each a carboxaldehyde, and R₂ is selected from the group of Cl, F and OH and R₄ and R₆ are each a hydrogen;
silicon nanoparticles embedded in the polydimethylsiloxane and cross-linker forming the composition that improves the hydrophobic properties of the composition.

22. The composition according to claim 21, wherein R₂ is chlorine.

23. The composition according to claim 21, wherein R₂ is fluorine.

24. The composition according to claim 21, wherein R₂ is hydroxy.

25. (canceled)
